(19) United States
(12) Patent Application Publication
(10) Pub. No.: US 2009/0162085 A1
(43) Pub. Date: Jun. 25, 2009

(54) Device for measuring electrostatic charge amount of toner and method for measuring distribution of electrostatic charge amount of toner

(75) Inventors: Hirotoshi Ikeya, Shizuoka-shi (JP); Hiroshi Kumashiro, Shizuoka-shi (JP); Nobuyuki Aoki, Shizuoka-shi (JP)

Correspondence Address: JORDAN AND HAMBURG LLP, 122 EAST 42ND STREET, SUITE 4000, NEW YORK, NY, 10168, US

(73) Assignee: Tomoegawa Co., Ltd., Chuo-ku (JP)

(21) Appl. No.: 12/316,976

(22) Filed: Dec. 18, 2008

(30) Foreign Application Priority Data
Dec. 19, 2007 (JP) 2007-326727

(51) Int. Cl. G03G 15/06

(52) U.S. Cl. 399/55

(57) ABSTRACT

A device for measuring electrostatic charge amount of toner is provided. The device comprises a hollow toner suction port for sucking the toner from a toner substrate and a means for measuring electrostatic charge amount of the sucked toner. The toner suction port forms a hermetically sealed space with the toner substrate.

Reference is hereby made to Japanese Patent Application No. 2007-326727 filed on Dec. 19, 2007, the entire disclosure of which is incorporated herein by reference.

### BACKGROUND OF THE INVENTION

### Field of the Invention

The present invention relates to devices for measuring electrostatic charge amount of toner to be used for electrophotography, electrostatic recording and so on and methods for measuring distribution of electrostatic charge amount of toner.

Electrostatic charge amount of toner is one of important parameters having influence on picture quality of images formed by electrophotography and, in order to obtain images of high picture quality, distribution of electrostatic charge amount of toner is measured and the results of such measurement are used for selection and determination of formulation of toner.

Conventional methods for measuring electrostatic charge amount of toner for electrophotography are generally classified into the blow off method and the suction method (refer to Patent Reference 1, for example).

FIG. 7 is a drawing illustrating a device for measuring electrostatic charge amount of toner by means of the blow off method.

C denotes a carrier, G denotes a direction of gas being sucked, T denotes toner, 4 denotes a means for measuring electrostatic charge amount, 7 denotes an electrode and 10 denotes a magnet.

According to the blow off method, a mixture of the toner T and the carrier C attracted and attached to each other through electrostatic attraction force by electrification is to be taken out and air is blown to it while the carrier is attracted to the magnet 10 to separate the toner T from the carrier C.

Within the means 4 for measuring electrostatic charge amount, the distribution of electrostatic charge amount is then given from the charge amount which the separated toner T has and the weight of the toner.

For example, according to a method wherein the separated toner is introduced between electrodes having a certain difference in potential, the toner T will be attracted to the electrode 7 having reversed polarity by its electrostatic force and deposited at different locations according to the electrostatic charge amount. In other words, if it has greater electrostatic charge amount, it will be deposited on the electrode 7 in the vicinity of the location of introduction and, if it has smaller electrostatic charge amount, it will be deposited on the electrode 7 at locations away from the location of introduction. The number of particles of the deposited toner T will be calculated on the basis of image analysis and the distribution of electrostatic charge amount can be given on the basis of the relationship among the locations of deposition, the number of deposited particles and the particle diameter.

Although the blow off method is widely applied to two component developers and so-called one and a half component developers using a magnetic toner and magnetic carrier, since the blow off method as described above uses a carrier, it cannot however be applied to one component developers without modification. As such, it is conceivable that a one component developer is mixed with a carrier to prepare a two component developer before measurement. Data was however unreliable because the conditions for measurement of the distribution of electrostatic charge amount are different from those for actual image formation.

On the other hand, methods for measurement suitable for one component developers include the suction method. According to the suction method, suction is effected through a pump by bringing a suction port close to the surface of developing rollers on which electrostatically charged toner is retained so that the toner may be separated and the separated toner may be introduced between electrodes in a manner similar to the blow off method described above to enable measurement of the distribution of electrostatic charge amount.

This method was, however, unable to provide precise measurements because when the suction force was greater, the toner introduced between the electrodes passed through the electrodes without being deposited on them. Conversely, when the suction force was smaller, it was difficult to separate the toner strongly attached to the developing rollers, reducing the amount sucked to make it unable to provide precise measurements.

Also, a method has been proposed in which a suction port is moved across developing rollers with reduced suction force to compensate for the reduction in the amount sucked. However, toner over the surface layer that is relatively low in electrostatic charge amount was preferentially collected to provide results somewhat different from the actual distribution of the electrostatic charge amount. Furthermore, continuous movement of the suction port across the developing rollers might do damage to the developing rollers which are soft, due to the material forming the suction port.

Patent Reference 1: Japanese Unexamined Patent Publication No. 2000-97981

### SUMMARY OF THE INVENTION

The present invention has been accomplished in the light of such problems as described above, and aims to provide devices for measuring electrostatic charge amount of toner and methods for measuring distribution of electrostatic charge amount of toner, capable of precise measurement without doing damage to developing rollers even when applied to one component developers.

The present invention has solved the above problems by the technical composition described below.

(1) A device for measuring electrostatic charge amount of toner, comprising a hollow toner suction port for sucking the toner from a toner substrate and a means for measuring electrostatic charge amount of the sucked toner, wherein the toner suction port forms a hermetically sealed space with the toner substrate.

(2) The device for measuring electrostatic charge amount of toner according to (1) above, wherein the toner suction port has a bell-shaped tip.

(3) A method for measuring distribution of electrostatic charge amount of toner, comprising the steps of sucking the toner through a toner suction port from a toner substrate and measuring distribution of electrostatic charge amount of the sucked toner, wherein the step of sucking the toner is a step in which the toner suction port is tightly attached to the toner substrate to form a hermetically sealed space and the toner is sucked in a spotwise manner.

(4) The method for measuring distribution of electrostatic charge amount of toner according to (3) above, wherein the toner suction port has a bell-shaped tip.

According to the present invention, devices for measuring electrostatic charge amount of toner and methods for measuring distribution of electrostatic charge amount of toner, capable of precise measurement without doing damage to developing rollers even when applied to a one component developer can be provided.

### BRIEF DESCRIPTION OF THE DRAWINGS

FIG. 1 is a view illustrating a device for measuring electrostatic charge amount of toner according to the present invention;

FIG. 2 is a view illustrating the suction port of Example 1, wherein (a) represents a bottom view and (b) represents a front view;

FIG. 3 is a view illustrating the suction port of Example 2, wherein (a) represents a bottom view and (b) represents a front view;

FIG. 4 is a view illustrating the suction port of Comparative Example 1, wherein (a) represents a bottom view and (b) represents a front view;

FIG. 5 is a view illustrating the suction port of Comparative Example 2, wherein (a) represents a bottom view and (b) represents a front view;

FIG. 6 is a view illustrating the suction port of Comparative Example 3, wherein (a) represents a bottom view and (b) represents a front view; and

FIG. 7 is a view illustrating a device for measuring electrostatic charge amount of toner on the basis of the blow off method.

### DETAILED DESCRIPTION OF THE PREFERRED EMBODIMENTS

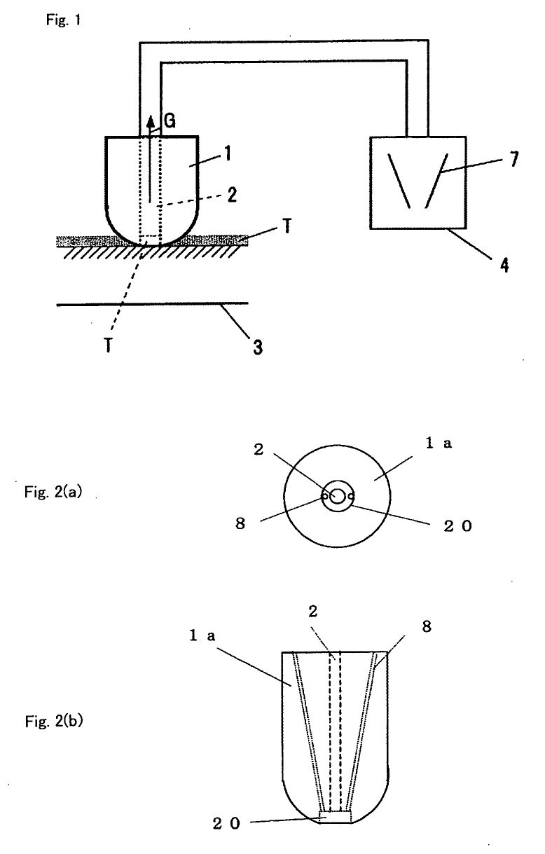

A device for measuring electrostatic charge of toner according to the present invention is described with reference to FIG. 1.

1 denotes a toner suction port, 2 denotes a pore, 3 denotes a toner substrate such as developing roller, 4 denotes a means for measuring electrostatic charge amount, 7 denotes an electrode, G denotes a direction of gas sucked and T denotes toner.

As illustrated in FIG. 1, the device for measuring electrostatic charge amount of toner according to the present invention comprises the toner suction port 1 for sucking toner and the means 4 for measuring electrostatic charge amount of the sucked toner.

The toner suction port 1 is hollow with the pore 2 and capable of collecting the toner T by sucking the toner together with a gas such as air.

Also, the toner suction port 1 has a bell-shaped tip.

Thus, even when the toner suction port 1 is forcibly pressed against and tightly attached to the toner substrate 3, the force will be distributed, preventing the tip of the toner suction port 1 from doing damage to the toner substrate 3.

Also, since the tip is bell-shaped, contact between the toner suction port 1 and the toner substrate 3 will be point contact rather than surface contact and the tip will be able to suck the toner T at a negative pressure by forming a minimum, hermetically sealed space with the toner substrate 3.

In this manner, even with one component developers which strongly attach to developing rollers, distribution of electrostatic charge amount can be measured.

Also, if a rubber cap is equipped with the tip of the toner suction port 1 and the point contact between the toner suction port 1 and the toner substrate 3 is made through this rubber cap, the toner substrate 3 may more preferably be protected against damages. Also, the toner suction port 1 may itself be made of a material such as rubber.

As the means for measuring electrostatic charge amount 4, electrode-attached devices and the like may be used. A conductive glass or tape is applied on plates of the electrodes 7 arranged in a nonparallel design to broaden toward the end. When a voltage is then applied between the electrodes and the sucked toner T is introduced between the electrodes, the toner T is attached on the conductive glass or tape at locations corresponding to the magnitude of electrostatic charge. The glass or tape with the toner attached is then removed from the electrodes and observed through optical microscopy to measure the distribution of electrostatic charge amount on the basis of image analysis using deposition locations, the number of toner particles and particle diameters.

Next, a method for measuring distribution of electrostatic charge amount of toner will be described.

The method for measuring distribution of electrostatic charge amount of toner according to the present invention comprises the steps of sucking the toner T through the toner suction port 1 from the toner substrate 3 and measuring the distribution of electrostatic charge amount of the sucked toner.

Then, in the step of sucking the toner, the toner suction port 1 is tightly attached to the toner substrate 3 to form a hermetically sealed space and the toner is sucked in a spotwise manner.

In other words, the toner suction port 1 collects the toner T while in contact with the toner substrate 3 without being moved.

According to this method, it is thought that the amount of sucked toner may be extremely reduced in comparison with a method in which the toner suction port 1 is moved across the toner substrate 3 and that variation may occur due to difference between individual toner in measurement of electrostatic charge amount to provide insufficient reproducibility.

In practice, however, it represents a highly reproducible method for measuring electrostatic charge amount, not doing damage to the toner substrate 3.

Although the causes are not necessarily clear, it is assumed that suction at a negative pressure by formation of a hermetically sealed space insures reproducibility by collecting the toner not only over the surface layer but also deep in the layer.

### EXAMPLES

The present invention will be described in more detail below with reference to examples which will in no way limit the present invention.

A commercially available laser printer using a nonmagnetic one component toner (printing speed: 24 A4 sheets per minute) was used to print two sheets with blank, before removing a developing device in which developing rollers made of polyurethane were housed.

Toner on the developing rollers was collected using suction ports of Examples and Comparative Examples and the distribution of electrostatic charge amount was measured using a means for measuring electrostatic charge (tradename “Q-test” by EPPING GmbH).

### Example 1

For Example 1, the suction port illustrated in FIG. 2 was used for sucking the toner.

FIG. 2 is a view illustrating the suction port of Example 1, wherein (a) represents a bottom view and (b) represents a front view.

1a denotes the suction port of Example 1 made of tetrafluoroethylene having a bell-shaped tip, 8 denotes an air supply pore with a diameter of 0.5 mm for blowing up toner like a cloud and 20 denotes a cylindrical space.

The suction port 1a forcibly presses the space 20 against developing rollers (not shown) for hermetically sealing, supplies air through the air supply pore 8 to blow up toner like a cloud in the space 20 and sucks at a negative pressure through a pore 2 to collect the toner.

The flow velocity of the supplied gas through the air supply port 8 was 60 ml/min, the flow velocity of the sucked gas through the pore 2 was 100 ml/min and the suction time was 5 seconds.

### Example 2

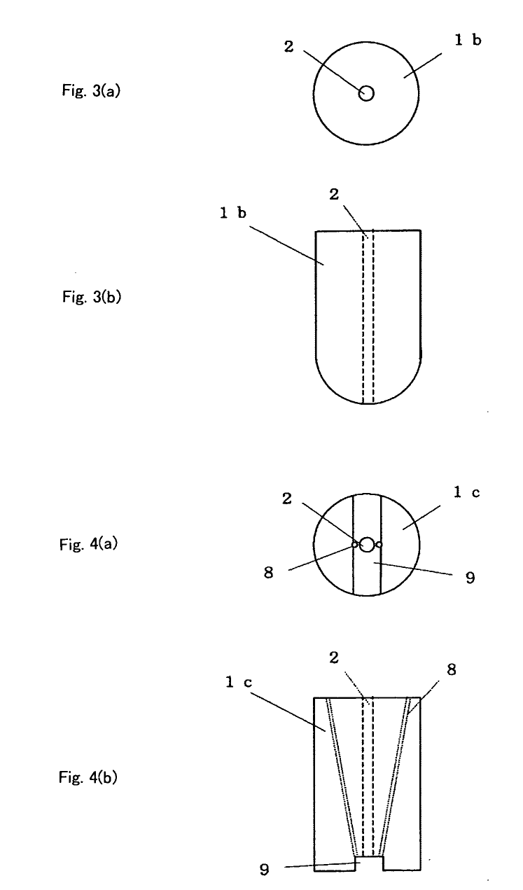

For Example 2, the suction port illustrated in FIG. 3 was used for sucking the toner.

FIG. 3 is a view illustrating the suction port of Example 2, wherein (a) represents a bottom view and (b) represents a front view.

1b denotes the suction port of Example 2 made of tetrafluoroethylene having a bell-shaped tip.

The suction port 1b forcibly presses a pore 2 against developing rollers (not shown) for hermetically sealing and sucks at a negative pressure to collect the toner.

The flow velocity of the sucked gas through the pore 2 was 100 ml/min and the suction time was 5 seconds.

### Comparative Example 1

For Comparative Example 1, the suction port illustrated in FIG. 4 was used for sucking the toner.

FIG. 4 is a view illustrating the suction port of Comparative Example 1, wherein (a) represents a bottom view and (b) represents a front view.

1c denotes the suction port of Comparative Example 1 made of tetrafluoroethylene having a cylindrical tip and 9 denotes a groove.

The suction port 1c forcibly presses the groove 9 against developing rollers (not shown), supplies air through an air supply port 8 to blow up toner like a cloud in the groove 9 and sucks through a pore 2 to collect the toner. The groove is open instead of closed and the reduction in the amount of the toner sucked was compensated for by sliding the suction port 1c across the developing rollers.

The flow velocity of the supplied gas through the air supply port 8 was 60 ml/min, the flow velocity of the sucked gas through the pore 2 was 100 ml/min and the suction time was 5 seconds.

### Comparative Example 2

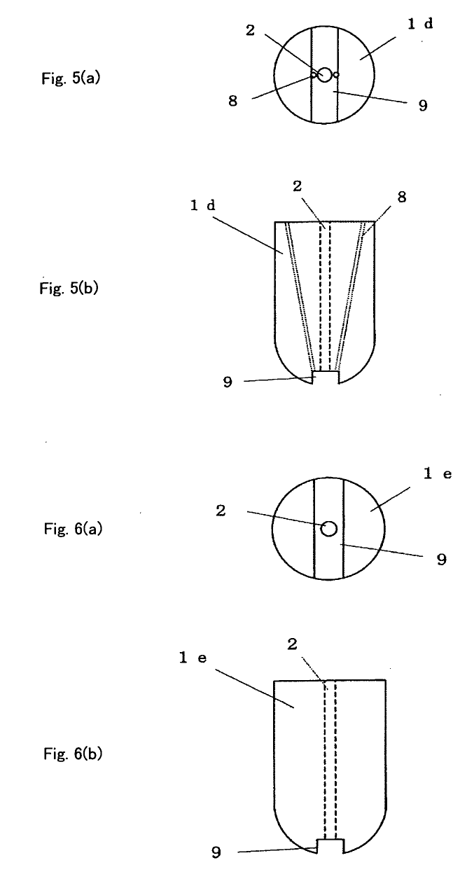

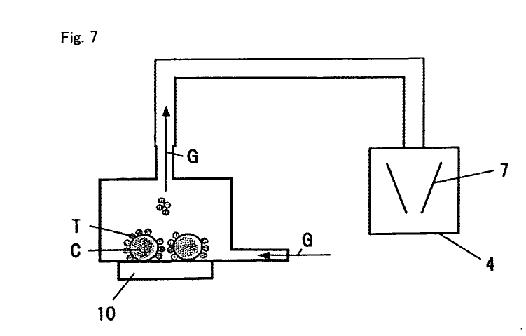

For Comparative Example 2, the suction port illustrated in FIG. 5 was used for sucking the toner.

FIG. 5 is a view illustrating the suction port of Comparative Example 2, wherein (a) represents a bottom view and (b) represents a front view.

1d denotes the suction port of Comparative Example 2 made of tetrafluoroethylene having a bell-shaped tip.

The suction port 1d forcibly presses a groove 9 against developing rollers (not shown), supplies air through an air supply port 8 to blow up toner like a cloud in the groove 9 and sucks through a pore 2 to collect the toner. The groove is open instead of closed and the reduction in the amount of the toner sucked was compensated for by sliding the suction port 1d across the developing rollers.

The flow velocity of the supplied gas through the air supply port 8 was 60 ml/min, the flow velocity of the sucked gas through the pore 2 was 100 ml/min and the suction time was 5 seconds.

### Comparative Example 3

For Comparative Example 3, the suction port illustrated in FIG. 6 was used for sucking the toner.

FIG. 6 is a view illustrating the suction port of Comparative Example 3, wherein (a) represents a bottom view and (b) represents a front view.

1e denotes the suction port of Comparative Example 3 made of tetrafluoroethylene having a bell-shaped tip.

The suction port 1e forcibly presses a groove 9 against developing rollers (not shown) and sucks through a pore 2 to collect the toner. The groove is open instead of closed and the reduction in the amount of the toner sucked was compensated for by sliding the suction port 1e across the developing rollers.

The flow velocity of the sucked gas through the pore 2 was 100 ml/min and the suction time was 5 seconds.

Main conditions for Examples and Comparative Examples are shown in Table 1.

TABLE 1

| | Shape of suction | space at time | |
|---|---|---|---|
| | port tip | of suction | air |
| Example 1 | bell-shaped | closed | supplied |
| Example 2 | bell-shaped | closed | not supplied |
| Com. Example 1 | cylindrical | open | supplied |
| Com. Example 2 | bell-shaped | open | supplied |
| Com. Example 3 | bell-shaped | open | not supplied |

Ten measurements were made on the distribution of electrostatic charge amount of the toner of Examples and Comparative Examples to make evaluations as follows.

### Scratches on Developing Rollers

Through visual inspection, the developing rollers were examined for scratches.
∘: scratches not found
×: scratches found

### Reproducibility

Ten distributions of electrostatic charge amount were seen by ten observers and the number of them who determined that the distributions were from the same toner was counted.
∘: 8 or more
Δ: 4 to 7
×: less than 3

TABLE 2

| | scratches on | |
|---|---|---|
| | developing rollers | reproducibility |
| Example 1 | ◯ | ◯ |
| Example 2 | ◯ | ◯ |
| Comparative Example 1 | X | Δ |
| Comparative Example 2 | X | Δ |
| Comparative Example 3 | X | X |

### Results of Evaluations

As can be seen from Table 2, for Examples 1 and 2, scratches on the developing rollers and reproducibility cause no problems as a matter of practice.

There was no toner left on the developing rollers where suction was made using Examples.

On the contrary, for Comparative Examples 1 and 2, scratches on the developing rollers cause problems as a matter of practice and reproducibility causes problems to some degree as a matter of practice.

For Comparative Example 3, scratches on the developing rollers and reproducibility cause problems as a matter of practice.

There was some toner left on the developing rollers where suction was made using Comparative Examples.

As described above, according to the present invention, devices for measuring electrostatic charge amount of toner and methods for measuring distribution of electrostatic charge amount of toner, capable of providing reproducible measurements without doing damage to developing rollers even when used with a one component developer may be provided.

What is claimed is:

1. A device for measuring electrostatic charge amount of toner, comprising a hollow toner suction port for sucking the toner from a toner substrate and a means for measuring electrostatic charge amount of the sucked toner, wherein the toner suction port forms a hermetically sealed space with the toner substrate.

2. The device for measuring electrostatic charge amount of toner according to claim 1, wherein the toner suction port has a bell-shaped tip.

3. A method for measuring distribution of electrostatic charge amount of toner, comprising the steps of sucking the toner through a toner suction port from a toner substrate and measuring distribution of electrostatic charge amount of the sucked toner, wherein the step of sucking the toner is a step in which the toner suction port is tightly attached to the toner substrate to form a hermetically sealed space and the toner is sucked in a spotwise manner.

4. The method for measuring distribution of electrostatic charge amount of toner according to claim 3, wherein the toner suction port has a bell-shaped tip.
